(19) United States
(12) Patent Application Publication
(10) Pub. No.: US 2004/0233919 A1
(43) Pub. Date: Nov. 25, 2004

(54) Method for operating a switching node in a data network

(76) Inventors: Johann Arnold, Wendelstein (DE); Dieter Klotz, Furth (DE); Christoph Munch, Eggenstein (DE); Jurgen Schmimmer, Nurnberg (DE)

Correspondence Address: Siemens Corporation, Intellectual Property Department, 170 Wood Avenue South, Iselin, NJ, 08830, US

(21) Appl. No.: 10/490,902

(22) PCT Filed: Sep. 13, 2002
(86) PCT No.: PCT/DE02/03440

(30) Foreign Application Priority Data
Sep. 26, 2001 (DE) 101 47 436.9
Aug. 14, 2002 (DE) 102 37 351.5

(51) Int. Cl. H04L 12/56

(52) U.S. Cl. 370/401

(57) ABSTRACT

The invention relates to a switching node and to a method for operating a switching node in a data network. Said method comprises the following steps: receipt of a data message at a first port of the switching node; verification of whether the data message is a broad cast data message. If said message is not a broadcast data message, the source address of the data message is passed to a dynamic address table and if said message and if this message is a data broadcast data message, the data message is forwarded via the additional ports of the switching node.

### CROSS REFERENCE TO RELATED APPLICATIONS

This application is the US National Stage of International Application No. PCT/DE02/03440, filed Sep. 13, 2002 and claims the benefit thereof. The International Application claims the benefits of German application No. 10147436.9 filed Sep. 26, 2001, and of German application No. 10237351.5 filed Aug. 14, 2002, all of the applications are incorporated by reference herein in their entirety.

### FIELD OF INVENTION

The invention relates to a method for operating a switching node in a data network, in particular a real time Ethernet, together with a suitable computer program product, a switching node and a communication system.

### BACKGROUND OF INVENTION

From prior art several types of data networks are known in which the data network components take a decision on which port belonging to the data network component concerned shall be used in order to send a data message. In particular data networks referred to as switchable are also known, in which a connection between two nodes is established in the data network by means of one or more point-to-point connections.

Likewise it is known from prior art that the decision on which port belonging to a data network component shall be used to send a previously received data message is made with the help of an address table. Each entry in the address table stores for example the station address of a destination data network component (known as a unicast address) or a multicast address or a network address together with the numbers of the ports belonging to the data network component concerned via which a received data message shall be routed to its destination address. Also known from prior art is the use of dynamically modifiable and static address tables. Dynamic address tables have dynamically modifiable table entries which are managed independently by the hardware of the data network component concerned without the support of any software. By contrast the static entries in a static address table are managed by the application software of each data network component and may not be modified by the hardware of a data network component.

A possibility known from prior art for detecting whether an address such as a multicast address and the information assigned to the multicast address are stored in an address table is to make a direct comparison between the destination address in the data message concerned and all the addresses stored in the address table. This method is time-consuming or requires a content-addressed memory.

A method enabling address entries which are initially mapped on the same vector address to be stored simultaneously in an address table is described in U.S. Pat. No. 5,923,660. For this purpose, a hash address table in an Ethernet controller is provided with a suitable control which forms the hash value of the address of a data packet in order to find an initial value for an entry point into the hash address table. If necessary this initial value is modified by a fixed step value if the address in the line to which the initial value points in the hash address table does not match the destination address.

Data networks enable communication between a plurality of nodes by linking them in a network, that is, by connecting individual nodes together. In this case communication means the transmission of data between nodes. Data requiring to be transmitted is sent in the form of data messages, which means that the data is assembled into a plurality of packets and sent in this form to the appropriate recipient via the data network. Such packets are therefore also known as data packets.

The term data transmission is used here as a synonym for the above-mentioned transmission of data messages or data packets. The actual linking in a network, for instance in the case of high-performance switchable networks such as Ethernet, is achieved in that between any two nodes there is at least one switching unit connected to both of the nodes. Each switching unit can be connected to more than two nodes.

Each node is connected to at least one switching unit but not directly connected to another node. A node may be a computer, a programmable logic controller (PLC) or some other machine which exchanges electronic data with other machines, in particular for processing. In contrast to bus systems, in which every node can access all the other nodes in the data network directly via the data bus, switchable data networks consist exclusively of point-to-point connections, which means that a node can access all the other nodes in a switchable data network only indirectly, by appropriate routing of the data with the aid of one or more switching units during transmission.

In distributed automation systems, such as in the field of drive technology, predetermined data must arrive at predetermined times at predetermined nodes and be processed by the recipients. In such cases the data or data traffic is said to be realtime-critical, since data failing to arrive at the predetermined place at the correct moment can lead to undesirable results at the node. According to IEC 61491, EN 61491 SERCOS System Interface, Technical Short Description (http://www.sercos.de/english/tech_doku.htm), it is possible for successful, realtime-critical data traffic of the above-mentioned type to be assured in distributed automation systems.

Known from prior art are various standardized communication systems, also called bus systems, for the purpose of exchanging data between two or more electronic modules or devices, and in particular for use in automation systems. Examples of such communication systems are field bus, process field bus (PROFIBUS), Ethernet, Industrial Ethernet, FireWire and also PC-internal bus systems (PCI). In each case these bus systems are designed or optimized for different areas of application, enabling a decentralized control system to be structured. Process monitoring and control in automated manufacturing, and particularly in the case of digital drive technology, requires very fast and reliable communication systems with predictable reaction times.

Synchronous communication systems supplied with clock pulses and having properties which include constant bus cycle time are known, particularly from the field of automation engineering. This is understood to mean a system that consists of at least two nodes which are connected to one another over a data network for the purpose of exchanging data with one another or transmitting data to one another. Data is exchanged in communication cycles at a constant cycle time governed by the system communication clock. Examples of nodes include centralized automation devices and devices for programming, configuration or operation, as well as peripherals such as input/output modules, drives, actuators, sensors, programmable logic controllers (PLC) or other control units, computers, or machines which exchange electronic data with other machines, in particular those which process data from other machines. In the rest of this document the term control unit shall be taken to mean controllers of all kinds including logic controllers and open-loop controllers.

A deterministic, cyclical data exchange taking place in communication systems at a constant cycle time is based on a clock or time base which is common to all components taking part in the communication. The clock or time base is transmitted to the other components by a component specially singled out for the purpose (clock generator). In the case of an isochronous real-time Ethernet, the clock or time base is specified by a synchronization master sending synchronization messages.

German patent application DE 100 58 524.8 discloses a system and a method for transmitting data via switchable data networks, in particular Ethernet, allowing a mixed operation of both realtime-critical and non-realtime-critical data communication, in particular for systems based on Internet or intranet.

From prior art it is also known that the components of a switchable data network use dynamic address tables in order to decide which port of a switching node shall be used to send a data message. A dynamic address table stores the station addresses of network components, in each case together with information about the port via which a data message shall be sent to the network node in question. Since the network configuration can change dynamically (for instance due to enabling or disabling actions or drop out or reassignment) and since limited memory capacity means that not all station addresses can be stored in an address table at the same time, the table entries managed by a network component such as a switching node are dynamically modifiable.

Since components of a data network may drop out or be reassigned, an aging mechanism can be provided so that an address entry can be declared invalid when a specific condition of the chosen aging method is fulfilled.

In such an aging method known from prior art, a data message must be received within a configurable time interval from the relevant network component with the station address entered in the address table in order for it to continue to be identified as valid.

FIG. 1 shows a data network known from prior art. The data network 1 contains a switching node 2 with ports A, B, C and D together with a switching node 3 with ports E, F, G and H. The port C of the switching node 2 is connected to an automation component 4 and the port B is connected to another switching node which is not shown in FIG. 1 for the sake of clarity.

Moreover the port D is connected to the port E of the switching node 3. The ports F, G and H of the switching node 3 are connected to the automation components 5, 6 and 7 respectively.

Each of the switching nodes 2 and 3 contains an address table 8. Each line of an address table 8 contains the station address of a component in the data network 1, for instance one of the automation components 4, 5, 6 or 7. In addition a relevant line of the address table 8 in the switching node contains information about the port of this switching node from which to forward a data message received by the switching node with the station address as destination address. Furthermore such a line in the address table 8 contains an entry about the aging of the entry in the line concerned, that is, about the validity of this entry.

An entry is generated in a line of the address table 8 when a data message 9 with a source address and a destination address is received, for example at the port A of the switching node 2. This may be an Ethernet data message, for instance.

The fact that a data message with the source address concerned has been received at the port A is recorded in the address table 8 as an entry in a line of the address table. An aging bit in the relevant line of the address table 8 is set to 0, for example, in order to indicate that this entry is current.

Each of the switching nodes 2 and 3 has a time base which applies globally to the address table 8. The time base can be provided by a counter which counts up to a threshold value in each case.

When a current entry has been generated in the address table 8 and the counter has been reset, the aging bit is set from 0 to 1, for example. The entry is still valid at that point. If another data message 9 is received at the moment in which the aging bit is set to 1, the aging bit is again reset to 0, for example. If this is not the case then the next time the counter is reset, the aging bit is set to 2, for example, indicating that the entry is invalid.

Management of the address tables 8 is carried out by means of a program 10.

In the case of data messages a distinction is generally made between the following categories:

unicast data messages are routed to a single network component,

multicast data messages are routed to a group of network components,

broadcast data messages are routed to all the components in a network.

If a network component receives a unicast or multicast data message, this component uses a unicast or multicast address table to decide on which port or ports shall be used in order to forward this message. Whereas the entries in a multicast address table are specified by configuration, the unicast address table contains a mixture of configured entries and dynamic entries.

Since broadcast data messages are routed to all network components, these messages are always sent via all ports and passed to the local user interfaces of the network components. Broadcast data messages can therefore place a significant load on a network and the computation units of the user interfaces.

The switching nodes usually operating at OSI layer 2 use the source addresses of incoming messages in order to structure their address tables. The address and the port on which the message concerned was received is noted in the address table. Incoming messages with a destination address that is present in the address table are directed to the specific port or ports recorded in the address table, thereby reducing the load on the network.

Bi-directional connections (such as TCP/IP connections) are commonly used between connected data terminals in a network that operates with the aid of switches. As a consequence of the filter characteristics of the switching nodes, this bidirectional (unicast traffic) remains confined to the part of the network to which the data terminals concerned are connected. Broadcast messages, on the other hand, are distributed to the entire layer 2 network and lead to a situation in which, when there are very large numbers of data terminals connected, the address tables of the switches “overflow” due to their limited size and new source addresses are no longer saved.

This in turn leads to a situation where even unicast data traffic is to some extent distributed across all the ports of a switch and the load separation in the network is thereby reduced. A frequently used method of reducing broadcast messages is to ensure that the number of broadcast messages sent is limited to an adjustable threshold value. In general the alternatives are to try to operate with very large address tables, which then require a correspondingly large amount of memory, or to accept a reduced load separation.

### SUMMARY OF INVENTION

The object of the invention is to create an improved method for operating a switching node in a data network, in particular real-time Ethernet, together with a corresponding computer program product, a switching node and a communication system.

The objects of the invention are achieved through the features of each of the corresponding main claims. Preferred embodiments of the invention are specified in the subclaims.

According to the invention a data message received by a switching node is immediately checked to find out whether it is a broadcast message. If it is not a broadcast message but a unicast message, the source address of the data message is passed to a dynamic address table. However, if the incoming data message is a broadcast message, the source address is not passed to the dynamic address table but the data message is simply forwarded via the additional ports of the switching node. The background for this action is the knowledge that a broadcast message, far from containing information relevant to the “training” of the dynamic address table, is in fact “flooded” with so much irrelevant information that even valuable information about the source addresses of the unicast messages can be lost. Therefore according to the invention, broadcast messages are not used for training dynamic address tables.

However, there can be situations in which it is sensible for address table training to include broadcast messages. For such cases it is advantageous if the inclusion of broadcast messages in address table training can be turned on and off.

According to a preferred embodiment of the invention, the check to find out whether a data message received by a switching node is a broadcast message is hardware-supported. It is preferable to use a logic circuit such as ASIC for this purpose. This has the advantage that the processor on which the application is running need not be delayed by the check on whether an incoming data message is a broadcast message.

According to another preferred embodiment of the invention, the address is used in order to check whether the message is a broadcast message.

According to a further preferred embodiment of the invention, a data message received by a switching node is immediately checked to find out whether it contains an ARP request (ARP: address resolution protocol) of the Internet protocol (IP). If this is the case, it is deduced from this that the data message is a broadcast message. The data message is passed to the user interface only in cases where the IP destination address of the incoming data message is the same as the IP station address of the switching node.

ARP request messages enable IP addresses to be mapped on physical (layer 2) addresses such as Ethernet addresses. ARP request messages are recognized by means of special identification characters from a MAC message, which for example in Ethernet are the type identifier 0806H. The necessary layer 3 information is contained in the user data field of this MAC message.

The present invention may be used with particular advantage for

reducing the load on the computation units of the network components by filtering unneeded ARP messages,

decoupling the filter function of the entries in the unicast address table from the multitude of broadcast messages received with different source addresses.

Particularly advantageous is the use of the filter mechanisms to which the invention relates for broadcast messages in the case of real-time Ethernet communication in the field bus area.

Also of particular advantage is the fact that the disclosed method can be put to use in automation systems, particularly in and for packaging machines, presses, plastic injection molding machines, textile machinery, printing machinery, machine tools, robots, handling systems, wood working machinery, glass forming machinery, ceramics forming machinery and lifting gear.

### BRIEF DESCRIPTION OF THE DRAWINGS

Features and advantages of preferred embodiments of the invention will emerge from the description which follows and from the accompanying drawings. These are:

FIG. 1 a block diagram of a communication system known from prior art with dynamic address tables in the switching nodes,

FIG. 2 a block diagram of an embodiment of a switching node to which the invention relates,

FIG. 3 a diagram showing a data message with an ARP request,

FIG. 4 a flow diagram showing a preferred embodiment of the principle by which the switching node in FIG. 2 operates,

FIG. 5 an embodiment of a communication system to which the invention relates, with a broadcast message,

FIG. 6 the communication system in FIG. 5 with a unicast message.

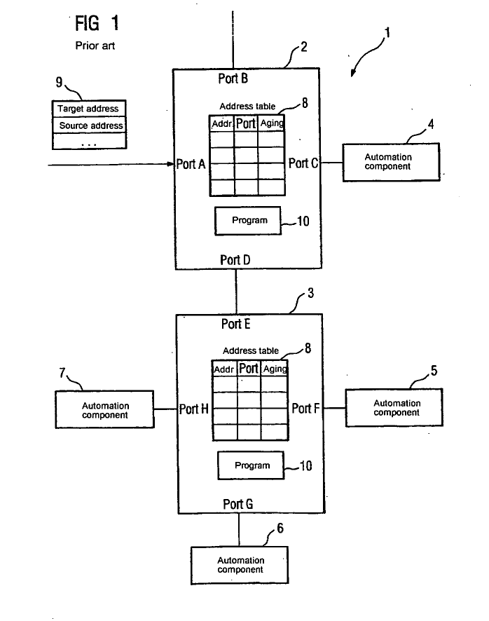

### DETAILED DESCRIPTION OF INVENTION

FIG. 2 shows a switching node 100 in a data network, and in this case the data network may be for instance a real-time Ethernet. The switching node has ports 102, 104, 106 and 108. The switching node 100 is connected to other switching nodes or destination nodes on the data network via ports 102 to 108.

The switching node 100 has a dynamic address table 110. Additionally the switching node 100 has a logic circuit 112 which in this case is preferably an ASIC module.

The switching node 100 also has a microprocessor 114 on which an application 116 is running.

When the switching node 100 receives a data message 118 on its port 102, the logic circuit 112 checks whether it is a broadcast message or a unicast message. If it is a unicast message, the source address of the data message 118 is passed to the address table 110 in order to update the table dynamically. If it is a broadcast message, however, the data message 118 is simply forwarded via the additional ports on the switching node, that is, ports 104, 106 and 108.

If a broadcast message is involved and the ARP protocol is being used, the logic circuit 112 goes on to check whether the IP destination address in the data message 118 matches the IP station address of the switching node 100. The data message 118 is only passed to the application 116 if this is the case. This has the advantage that no load is placed on the processing capacity of the processor 114 by ARP broadcast messages which do not have the switching node 100 as their IP destination address.

Another particular advantage is that the dynamic address table 110 is not “flooded” with the source addresses of broadcast messages, but instead only unicast messages are used for dynamic adaptation of the address table 110.

The logic circuit 112 recognizes broadcast messages with the aid of a special layer 2 MAC address from the seven-layer OSI (open systems interconnection) model, where for instance in the case of an Ethernet application the field for the destination address contains logical ones only.

Various filter mechanisms are possible for filtering out broadcast messages:

Broadcast messages are passed to the user interface of a network component only if they are of a defined type and have a configurable address from layer 3 of the seven-layer OSI model. An example of this is the case of ARP request messages (ARP: address resolution protocol) from the Internet protocol (IP) with a destination IP address which must be the same as the IP address of the switching node receiving the messages. All other layer 3 broadcast messages of this type are filtered.

In general the preferable way of proceeding with broadcast messages is to apply filtering rules to the message. The message is forwarded to the application only if these filtering rules are fulfilled.

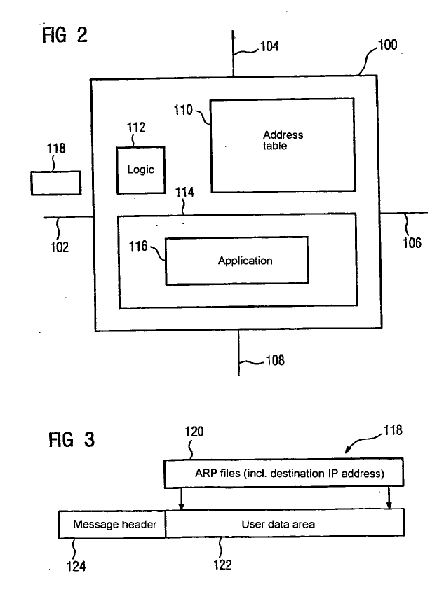

Another filter mechanism is shown in FIG. 3. This figure shows a data message 118 with an ARP request 120 which contains a destination IP address.

The data message 118 also has a user data area 122 and a message header 124.

The data message 118 with the ARP request message 120 enables IP addresses to be mapped on physical (layer 2) addresses such as Ethernet addresses. The ARP request 120 can be recognized by means of a special identifier from a MAC frame, which for example in Ethernet is the type identifier 0806H. The necessary layer 3 information is contained in the user data field 122.

The logic circuit 112 (cf. FIG. 2) immediately checks an incoming data message to find out whether it contains a broadcast address or an ARP request 120. If this is the case, it is a broadcast message.

FIG. 4 shows a flow diagram of a preferred embodiment of a method for operating a switching node as shown in FIG. 2.

In the step 400 a data message is received at a port on the switching node. In the step 402 a hardware-supported check is performed to find out whether the data message is a broadcast message. If this is not the case, the data message is used to train a dynamic address table in the step 404. In the step 406 the data message is forwarded via at least one port on the switching node according to its destination address, or passed to the application on the switching node if the destination address of the data message is the same as the station address of the switching node.

If the result of the check in the step 402 is that the message is a broadcast message, the step 408 checks whether the destination IP address of the broadcast message is the same as the IP station address of the switching node. If this is the case, the step 410 passes the broadcast message to the application if the filtering rules are fulfilled. The step 412 then forwards the broadcast message via all the additional ports on the switching node.

FIG. 5 shows a communication system with a data network 600 to which nodes Tn_1, Tn_2, Tn_3, Tn_4 and Tn_5 are connected. The nodes are in the main structured in the same way as the switching node 100 in FIG. 2. The node Tn_1 knows only the IP address of Tn_5. To find out the physical MAC address also, Tn_1 sends an ARP request in the form of a broadcast message. Using the filter function to which the invention relates, this message is sent only to the application of Tn_5, that is, no user interface of any other network node receives this ARP request.

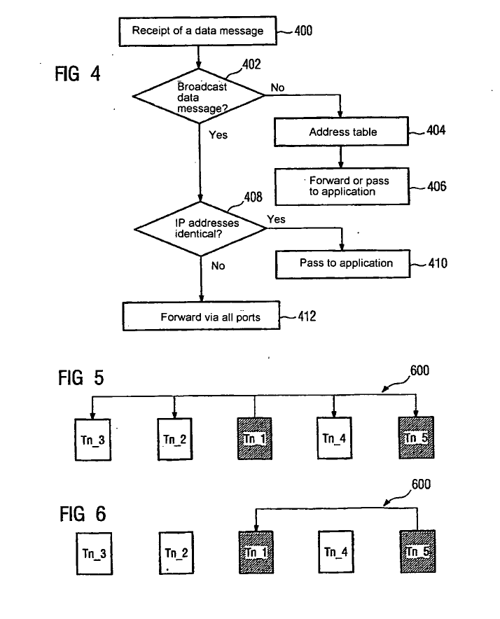

FIG. 6 shows the data network 600 after the node Tn_5 has received the broadcast message with the ARP request from node Tn_1. The node Tn_5 processes the ARP request and answers node Tn_1 with its MAC address, which corresponds to the destination IP address. This response is therefore in the form of a unicast message.

1. A method for operating a switching node in a field bus of an automation system, in which the field bus is designed for real-time communication, comprising:
receiving a data message at a first port of the switching node;
checking whether the data message is a broadcast message; if the data message is not a broadcast data message:
passing the source address of the data message to a dynamic address table; if said message is a broadcast data message:
forwarding the data message via the additional ports of the switching node.

2. A method according to claim 1, wherein broadcast data messages are selectively passed to the dynamic address table.

3. A method according to claim 1, wherein for the purpose of checking whether the data message is a broadcast data message, a check is made on whether the data message contains an ARP request.

4. A method according to claim 1, wherein if said data message is a broadcast data message, an IP destination address of the data message is compared with the IP address of the switching node and the data message is not forwarded via the additional ports of the switching node if the IP destination address matches the IP address of the switching node.

5. A method according to claim 1, wherein the broadcast data message is passed to an application of the switching node only if the IP destination address matches the IP address of the switching node.

6. A computer program product for a switching node in a field bus of an automation system, in which the field bus is designed for real-time communication for performing a method, the method comprising:
receiving a data message at a first port of the switching node;
checking whether the data message is a broadcast message,; if the data message is not a broadcast data message:
passing the source address of the data message to a dynamic address table; if said message is a broadcast data message:
forwarding the data message via the additional ports of the switching node.

7. A computer program product according to claim 6, further comprising program elements for checking whether the data message is a broadcast data message, and checking whether the data message contains an ARP request.

8. A computer program product according to claim 6, wherein the broadcast data message is passed to an application of the switching node only if the IP destination address matches the IP address of the switching node.

9. A switching node for a field bus of an automation system, in which the field bus is designed for real-time communication, comprising:
a plurality of ports for receiving and sending data messages;
a dynamic address table;
an element for checking whether an incoming data message is a broadcast data message;
an element for passing a source address of an incoming data message to the dynamic address table if the said message is not a broadcast data message; and
an element for forwarding an incoming data message via the additional ports of the switching node.

10. A switching node according to claim 9, wherein the element for checking is designed so that for the purpose of checking whether the data message is a broadcast data message, a check is made on whether the data message contains an ARP request.

11. A switching node according to claim 9, wherein the element for forwarding is designed so that forwarding does not occur if the said data message is a broadcast data message and an IP destination address of the data message matches the IP address of the switching node.

12. A switching node according to claim 9, further comprising an element for passing the broadcast data message to an application of the switching node only if the IP destination address matches the IP address of the switching node.

13. A switching node according to claim 9 for use in a communication system.

14. A method according to claim 2, wherein for the purpose of checking whether the data message is a broadcast data message, a check is made on whether the data message contains an ARP request.

15. A method according to claim 2, wherein if said data message is a broadcast data message, an IP destination address of the data message is compared with the IP address of the switching node and the data message is not forwarded via the additional ports of the switching node if the IP destination address matches the IP address of the switching node.

16. A method according to claim 3, wherein if said data message is a broadcast data message, an IP destination address of the data message is compared with the IP address of the switching node and the data message is not forwarded via the additional ports of the switching node if the IP destination address matches the IP address of the switching node.

17. A method according to claim 2, wherein the broadcast data message is passed to an application of the switching node only if the IP destination address matches the IP address of the switching node.

18. A switching node according to claim 10, wherein the element for forwarding is designed so that forwarding does not occur if the said data message is a broadcast data message and an IP destination address of the data message matches the IP address of the switching node.
